(19) United States
(12) Patent Application Publication
(10) Pub. No.: US 2007/0108402 A1
(43) Pub. Date: May 17, 2007

(54) Sealed hub for motor actuated valve

(76) Inventor: Jeremiah Davis, Lebanon, TN (US)

Correspondence Address: HARNESS, DICKEY & PIERCE, P.L.C., P.O. BOX 828, BLOOMFIELD HILLS, MI, 48303, US

(21) Appl. No.: 11/404,032

(22) Filed: Apr. 13, 2006

Related U.S. Application Data
(60) Provisional application No. 60/736,535, filed on Nov. 14, 2005.

(51) Int. Cl. F16K 31/00

(52) U.S. Cl. 251/293

(57) ABSTRACT

A sealing hub assembly is provided for a valve having a stem boss and a stem rotatably received in the stem boss. The stem is normally rotated by a motor/actuator. To seal a leaking stem, a hub body is connected to the stem boss which is also used to releasably mount the motor/actuator. An adapter is threaded into the hub body. A stem extender is rotatably supported in the adapter which is coupled at a first end for co-rotation with the stem, and is coupled at a second end to the motor/actuator. To provide an external fluid seal for the leaking stem, a first seal is positioned between the stem extender and the adapter, and a second seal is positioned between the adapter and the stem boss.

### CROSS-REFERENCE TO RELATED APPLICATIONS

This application claims the benefit of U.S. Provisional Application No. 60/736,535, filed on Nov. 14, 2005. The disclosure of the above application is incorporated herein by reference.

### FIELD

The present invention relates in general to motor actuated valves and more specifically to a device and method for sealing a connection between a valve and a valve actuator.

### BACKGROUND

Valves are commonly operated by installation of a motor operated actuator which is installed on the valve and externally connected by a connector assembly to a stem or stem extension of the valve. Certain valve designs provide stem geometries which require the stem to be loaded through the valve internal cavity. The valve must therefore be disassembled for maintenance access to the stem and/or stem seals. Valves in some applications including but not limited to refrigerant service valves have body connections which are welded or sealed in a manner which does not permit subsequent access to the internal components of the valve to replace items such as gaskets, seals or internal components. In these applications, if the stem seals leak, access through the valve body to the stem seals is not a cost effective option.

A method and device to externally seal a leaking stem area is therefore desirable for motor actuated valves. For motor operated valves, removal and reassembly of the actuator must also be considered when repairing the leaking stem to ensure the actuator can be reassembled and realigned for proper operation of the valve.

### SUMMARY

According to some embodiments of the present invention, a sealing hub assembly is adapted for installation to a motor actuated valve. The sealing hub assembly includes a hub body adapted to engage a stem boss of the valve, and is operable to releasably mount a motor/actuator. An adapter member is internally received within the hub body. A stem extender is retained by the adapter member. The stem extender is coupled at a first end for co-rotation with a stem of the valve, and is coupled at a second end to the motor/actuator. A first seal is disposed between the stem extender and the adapter.

According to further embodiments, a sealing hub assembly is provided for a valve having a stem boss and a stem rotatably received in the stem boss. The stem is normally rotated by a motor/actuator. To seal a leaking stem, a hub body is connected to the stem boss which is also used to releasably mount the motor/actuator. An adapter is threaded into the hub body. A stem extender is rotatably supported in the adapter and is coupled at a first end for co-rotation with the stem, and coupled at a second end to the motor/actuator. To provide an external fluid seal for the leaking stem, a first seal is positioned between the stem extender and the adapter, and a second seal is positioned between the adapter and the stem boss.

According to still further embodiments, a method is provided for installing a sealing assembly between a valve and a valve motor/actuator which is operable to externally seal a leaking stem seal. The sealing assembly has a cylindrical portion and flange portion, an adapter engageable to the cylindrical portion, and a stem extender. The valve has a stem rotatably received within a stem boss. The method includes positioning the first sealing member on the stem extender. The method also includes inserting the stem extender into the adapter to operably engage the first sealing member between the stem extender and the adapter. The method further includes urging the adapter into engagement with the flange portion. The method still further includes positioning a second sealing member between the adapter and the stem boss. The method yet further includes releasably engaging the cylindrical portion to the stem boss to operably engage the second sealing member to both the adapter and the stem boss.

A sealed hub assembly of the present invention offers several advantages. By using sealing elements which are positioned external to the valve assembly, any leaking seals of an existing valve which would otherwise permit atmospheric leakage are isolated. The sealed hub assembly of the present invention also provides simple mechanical connection to an existing body stem boss without further modification or machining of the body stem boss. This permits for rapid installation of a sealed hub assembly of the present invention for the existing connectors of body stem boss 52. A further advantage is provided by stem extender 38 which adapts to the existing or other known motor actuators with minimal power loss. The various sealing elements of a sealed hub assembly of the present teachings are also themselves easily replaceable if subsequent leakage past these seal elements occurs.

Further areas of applicability of the present teachings will become apparent from the detailed description provided hereinafter. It should be understood that the detailed description and specific examples, while indicating several embodiments of the present teachings, are intended for purposes of illustration only and are not intended to limit the scope of the teachings.

### BRIEF DESCRIPTION OF THE DRAWINGS

The present teachings will become more fully understood from the detailed description and the accompanying drawings, wherein:

FIG. 1 is a perspective view of a valve assembly including a sealed hub of the present teachings;

FIG. 2 is a side elevational view of the valve assembly of FIG. 1;

FIG. 3 is a cross sectional side elevational view of the valve assembly of FIG. 2;

FIG. 4 is an end elevational view at end 4 of FIG. 2;

FIG. 5 is a top plan view taken at section 5-5 of FIG. 4;

FIG. 6 is an enlarged cross sectional view taken at area 6 of FIG. 3;

FIG. 7 is a side elevational view of a stem extender of the present teachings; and

FIG. 8 is a cross sectional side elevational view of an adapter of the present teachings.

### DETAILED DESCRIPTION

The following description of several embodiments of the present teachings is merely exemplary in nature and is in no way intended to limit the present teachings, their application, or uses.

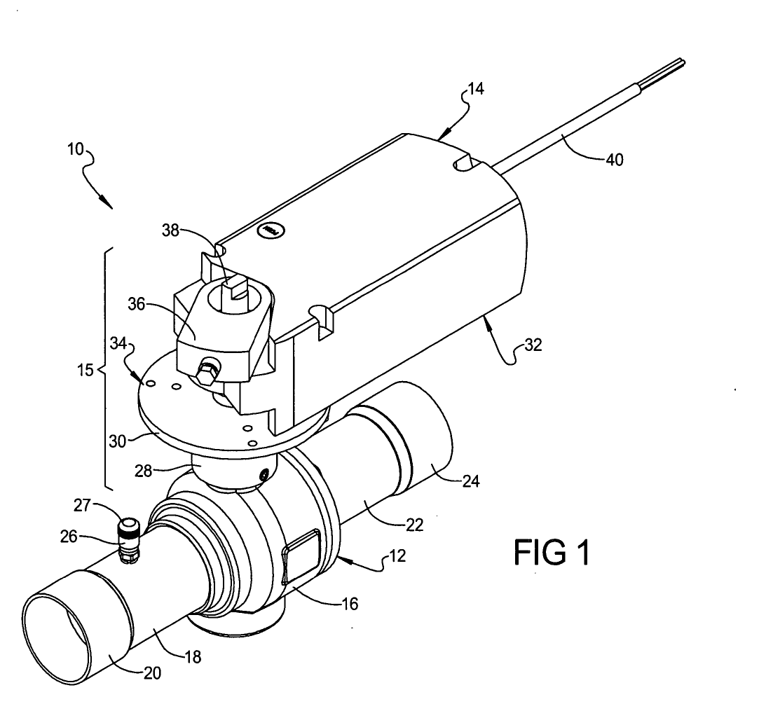

According to several embodiments of the present teachings and with reference to FIG. 1, a valve assembly 10 includes a valve 12 having a connected motor/actuator 14. Motor/actuator 14 can be an electric, a hydraulic, or a pneumatic motor. A sealed hub assembly 15 adaptably connects motor/actuator 14 to valve 12 and provides additional sealing capability to prevent leakage of system fluid past the primary stem seals from escaping to atmosphere.

Valve 12 further includes an inlet branch 18 having an inlet adapter 20 and an outlet branch 22 having an outlet adapter 24. The designation of “inlet” and “outlet” branches is for convenience only, as the configuration of valve 12 can include the inlet or the outlet at either end of valve 12. A branch connector port 26 is connected for example to inlet branch 18. Branch connector port 26 provides a mechanical connection for a hose or tube to be temporarily or permanently connected to valve 12. Branch connector port 26 therefore allows system fluid to be added or bled from the fluid system to which valve 12 is connected. If the hose or tube (not shown) is not connected to branch connector port 26, a seal cap 27 is installed to act as a fluid system boundary.

Sealed hub assembly 15 includes a hub body 28 which is connected to valve body 16. Hub body 28 includes a radial flange 30. Motor/actuator 14 is connected to radial flange 30 by joining a motor first or bottom face 32 with a flange first or upper face 34 of radial flange 30. An adjustment device 36 is also commonly provided with motor/actuator 14. Adjustment device 36 can be used to control the total rotational displacement of a stem extender 38 and thereby control a degree of rotational movement of an isolation member (for example a ball with flow ports) provided within valve body 16. A power source line 40 is also commonly provided with motor/actuator 14. Power source line 40 in some embodiments is an electrical power cord for providing for example alternating current or direct current electrical voltage to operate motor/actuator 14. In other embodiments, power source line 40 can provide one or more hydraulic or pneumatic tubes to support hydraulic or pneumatic operation of motor/actuator 14.

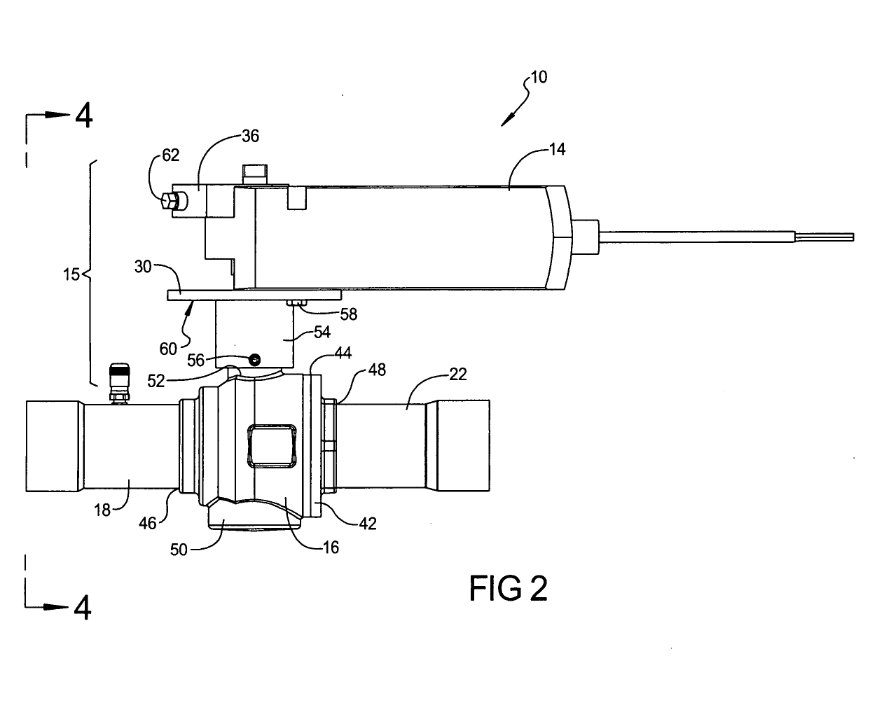

As best seen in reference to FIG. 2, sealed hub assembly 15 is advantageously used for valves 12 which have sealed body connections. For example, an end fitting 42 is sealed to valve body 16 with a seal joint 44 which in some embodiments is a weld joint or brazed joint. Inlet branch 18 is sealed to valve body 16 using an inlet branch seal joint 46 which in some embodiments is a weld joint or a brazed joint. Similarly, outlet branch 22 is sealed to end fitting 42 using an outlet branch seal joint 48 which again can include a weld joint or a brazed joint. Valve 12 can also be provided with a body support member 50 which commonly acts as a body mounting attachment for valve 12 to structure or other system components. Valves 12 having sealed joints as noted herein are commonly used in fluid applications where atmospheric leakage is unacceptable. For example, such fluid applications include refrigerant service. The complications created by sealing the various joints of valve 12 include the difficulty of subsequent removal and maintenance of sealing members used within valve 12.

When valves 12 are sealed as described above, leakage of system fluid in the area of a body stem boss 52 can create flow paths for system fluids directly to the atmosphere. It is in part to correct or eliminate this leakage path that sealed hub assembly 15 is provided. Sealed hub assembly 15 further includes a cylinder section of hub body 28 which is mechanically connected to body stem boss 52 using a retention element 56. Examples of retention elements 56 included threaded pin elements, through-pin elements or similar fasteners.

With further reference to FIG. 2, one or more fasteners 58 mechanically connect motor/actuator 14 to radial flange 30 by inserting fastener(s) 58 from a flange lower face 60 side of radial flange 30. An adjustment element 62 can also be provided with adjustment device 36. Examples of adjustment elements 62 include hex or square ended threaded fasteners to which a tool (not shown) can be used to apply a torque to adjustment element 62 to effectively lock adjustment device 36 in position.

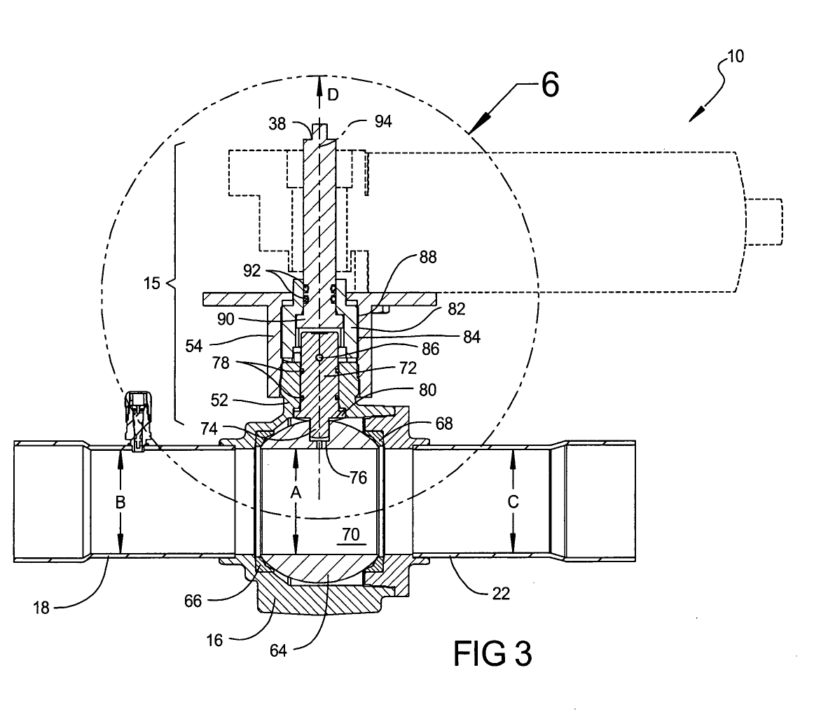

Referring now generally to FIG. 3, and for exemplary purposes only, valve 12 is hereinafter described in reference to a ball valve having a ball 64 rotatably disposed within valve body 16. Valve 12 is not limited to ball valves, and other rotationally operated valves such as gate, globe and throttling valves can also be used. Ball 64 is provided with first and second ball seals 66, 68 proximate to flow port connections servicing each of inlet and outlet branches 18, 22. A ball through-bore 70 includes a ball through-bore diameter “A” which in some embodiments is sized to substantially equal each of an inlet branch bore diameter “B” of inlet branch 18 and an outlet branch bore diameter “C” of outlet branch 22. Ball 64 is rotatably actuated by rotation of a main stem 72. Main stem 72 includes a male element 74 which is connectably fitted within a slot 76 created in ball 64. Main stem 72 is provided with first seal elements 78, such as O-rings, to provide a primary fluid boundary seal between main stem 72 and body stem boss 52.

In applications where high pressure within valve body 16 could otherwise adversely tend to drive main stem 72 outwardly, a stem radial flange 80 is often provided. Stem radial flange 80 abuts with a shoulder area internally positioned within body stem boss 52 to prevent outward displacement of main stem 72. When stem radial flanges 80 are used, however, and particularly with valve designs having sealed end connections, leakage of first seal elements 78 would require disassembly of the various sealed joints of valve 12 to allow removal of ball 64 and main stem 72 to replace first seal elements 78. Due to the obvious cost and difficulty of disassembling valve 12 in this manner, sealed hub assembly 15 is provided to add additional external seals to prevent system fluid escaping past first seal elements 78 from escaping to the atmosphere.

To provide this additional external sealing function, sealed hub assembly 15 further includes an adapter sleeve 82 which is internally positioned within hub body 28 and rotatably supports stem extender 38. Adapter sleeve 82 is retained within hub body 28 using for example a threaded joint 84. An aperture 86 previously created in main stem 72 receives retention element 56 having a portion which extends beyond main stem 72 to be received in one or more recesses (not shown) on an end face of stem boss 52. Retention element 56 engages end faces (not shown) of the recess(es) to limit rotation of main stem 72 to a predetermined arc of rotation, normally 90 degrees for a ball valve. A shoulder portion 88 of adapter sleeve 82 acts as a retention element to retain an extension stem radial flange 90 of stem extender 38. Shoulder portion 88 prevents outward displacement in a displacement direction “D” of stem extender 38. Extension stem radial flange 90 therefore has a similar function to stem radial flange 80. At least one and in several embodiments a plurality of second seal elements 92 are disposed about stem extender 38 to provide an additional fluid seal between stem extender 38 and an inner bore wall of adapter sleeve 82. In some embodiments, second seal elements 92 are O-rings of a polymeric or a rubber type material. Second seal elements 92 also permit rotational displacement of stem extender 38 while simultaneously providing a fluid boundary seal. Each of the stem extender 38 and main stem 72 commonly rotate about a ball-stem rotational axis 94.

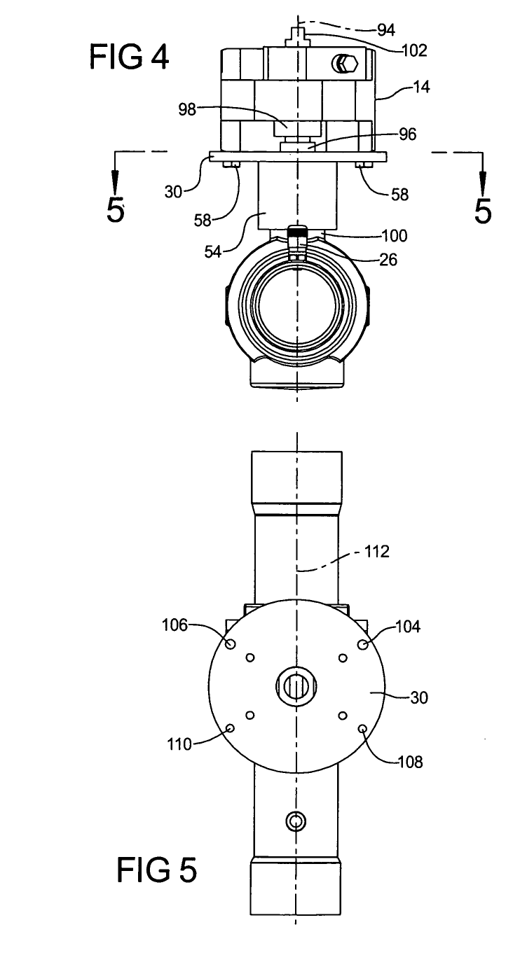

Referring now generally to FIG. 4, a sleeve member 96 of adapter sleeve 82 extends beyond radial flange 30 as shown and rotatably receives stem extender 38. A bearing sleeve 98 is provided with motor/actuator 14 to also rotatably receive stem extender 38. A connecting joint 100 which in several embodiments of the present teachings includes a threaded joint is provided on body stem boss 52 to mechanically couple cylinder section 54 of hub body 28 to body stem boss 52. Cylinder section 54 is adapted to engage with connecting joint 100 which is previously provided with valve 12, and otherwise receives an end cap which normally retains main stem 72. This cap (not shown) is removed prior to installation of cylinder section 54 of sealed hub assembly 15. A male element 102 can be provided at a distal end of stem extender 38 similar to male element 74 of main stem 72. Male element 102 can be provided for example for attachment of a retention tool during adjustment of adjustment device 36. Male element 102 can also functionally receive a tool such as a wrench which can be used to manually rotate stem extender 38 and thereby main stem 72, to manually actuate ball 64 if power is not available to motor/actuator 14. Branch connector port 26 is shown substantially co-axially aligned with ball/stem rotational axis 94, however, branch connector port 26 can be rotated about inlet branch 18 to an alternate position from that shown.

Referring now generally to FIG. 5, a first, second, third and fourth fastener aperture 104, 106, 108, 110 are created in radial flange 30 and sized accordingly to receive fasteners 58 used to connect motor/actuator 14 to valve body 16. Radial flange 30 is aligned with a valve longitudinal axis 112.

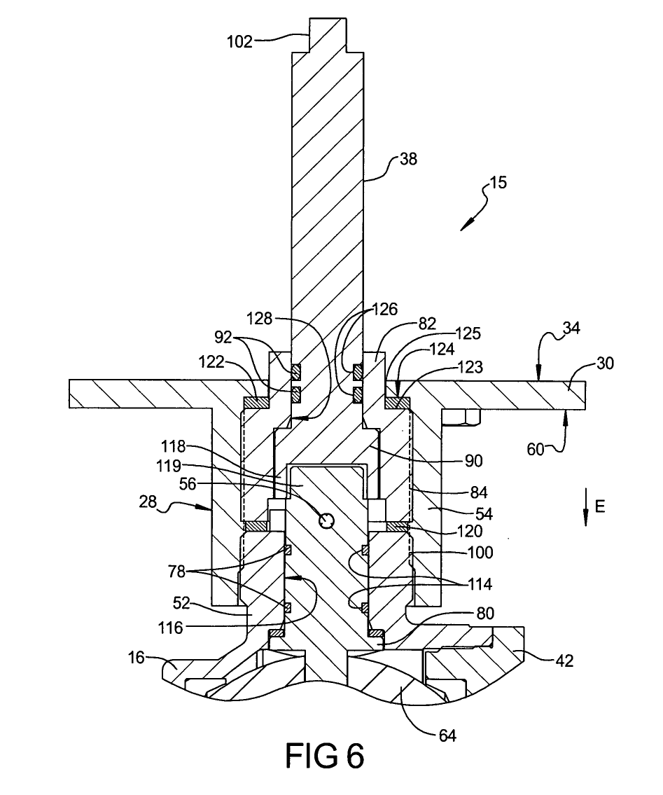

Referring in general now to FIG. 6, further details of sealed hub assembly 15 are shown. Also shown are one or more annular grooves 114 created about main stem 72 which receive each of first seal elements 78. First seal elements 78 therefore seat against an inner face 116 of body stem boss 52. Fluid leakage past any of first seal elements 78 is retained by sealed hub assembly 15. To rotatably engage stem extender 38 with main stem 72, a slotted end 118 of stem extender 38 is engaged with a male end 119 of main stem 72. A first washer-type seal element 120 created of a polymeric or similar sealing material can be disposed between an end face of body stem boss 52 and a corresponding end face of adapter sleeve 82. In other embodiments, a second washer-type seal element 122, which is used in lieu of first washer-type seal element 120, can be positioned between an exterior radial face 123 of adapter sleeve 82 and an inner face 124 of radial flange 30 proximate to an aperture 125 created in radial flange 30. When second washer-type seal element 122 is used, an additional seal (not shown) is also provided between cylinder section 54 and stem boss 52. Use of first washer-type seal element 120 does not require the further seal at cylinder section 54 and is therefore a less complex/expensive option. To further control any leakage of fluid past first seal elements 78, and to control the location of the second seal elements 92, at least one and in some embodiments a plurality of annular grooves 126 are created in stem extender 38, each receiving one of the second seal elements 92. Second seal elements 92 therefore provide a fluid seal between stem extender 38 and an inner face 128 of adapter sleeve 82 while permitting rotation of stem extender 38.

First or second washer-type seal elements 120,122 and second seal elements 92 therefore define external boundaries for preventing fluid leakage past first seal elements 78 from escaping to the atmosphere. By positioning each of the sealing elements external to main stem 72, the internal components of valve 12 do not have to be removed in order to repair a leaking valve 12. Sealing pressure for first or second washer-type seal elements 120, 122 is provided by engaging hub body 28 with body stem boss 52 in an engagement direction “E” using connecting joint 100 and threaded joint 84.

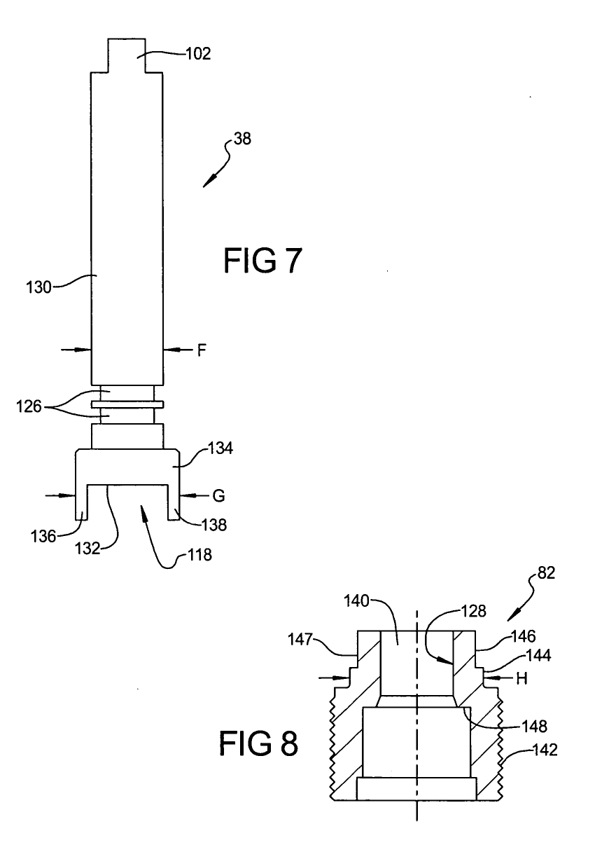

Referring now to FIG. 7, stem extender 38 further includes a cylindrical shaft 130 positioned between male element 102 and slotted end 118. Cylindrical shaft 130 has a shaft diameter “F” sized to be rotatably received against inner diameter face 128 of adapter sleeve 82. Slotted end 118 includes an end face 132 created in a cylindrical head 134. Cylindrical head 134 has a head diameter “G” which is greater than shaft diameter “F”. Opposed first and second slot walls 136, 138 extend perpendicularly with respect to end face 132. First and second slot walls 136, 138 engage male end 119 of main stem 72 to transfer the rotational torque of motor/actuator 14 to main stem 72. Annular grooves 126 are positioned proximate to cylindrical head 134.

Referring now to FIG. 8 and with further reference to FIGS. 6 and 7, adapter sleeve 82 includes an aperture 140 which rotatably receives cylindrical shaft 130 of stem extender 38. A plurality of male threads 142 threadably engage corresponding female threads of cylinder section 54 to create threaded joint 84. An outer sleeve 144 having a sleeve diameter “H” is received in aperture 125 of radial flange 30. First and second engagement faces 146, 147 are created in outer sleeve 144 to act as tool engagement faces for rotationally tightening adapter sleeve 82 in cylinder section 54 of hub body 28. An inner shoulder 148 engages extension stem radial flange 90 to retain stem extender 38.

A sealed hub assembly of the present invention offers several advantages. By using sealing elements which are positioned external to the valve assembly, any leaking seals of an existing valve which would otherwise permit atmospheric leakage are isolated. The sealed hub assembly of the present invention also provides simple mechanical connection to an existing body stem boss without further modification or machining of the body stem boss. This permits for rapid installation of a sealed hub assembly of the present invention for the existing connectors of body stem boss 52. A further advantage is provided by stem extender 38 which adapts to the existing or other known motor actuators with minimal power loss. The various sealing elements of a sealed hub assembly of the present teachings are also themselves easily replaceable if subsequent leakage past these seal elements occurs.

The description of the present teachings is merely exemplary in nature and, thus, variations that do not depart from the gist of the present teachings are intended to be within the scope of the present teachings. Such variations are not to be regarded as a departure from the spirit and scope of the present teachings.

What is claimed is:

1. A sealing hub assembly adapted for installation to a motor actuated valve, the sealing hub assembly comprising:
a hub body adapted to engage a stem boss of the valve, and operable to releasably mount a motor/actuator;
an adapter member internally received within the hub body;
a stem extender retained by the adapter member, the stem extender coupled at a first end for co-rotation with a stem of the valve, and coupled at a second end to the motor/actuator; and
a first seal disposed between the stem extender and the adapter.

2. The assembly of claim 1, wherein the first seal comprises an O-ring.

3. The assembly of claim 2, wherein the stem extender further comprises an annular groove adapted to receive the O-ring.

4. The assembly of claim 1, further comprising a second seal disposed between the stem boss and the adapter.

5. The assembly of claim 4, wherein the second seal further comprises a washer-type seal.

6. The assembly of claim 1, further comprising:
a plurality of male threads of the stem boss;
a cylinder section of the hub body having internal female threads adapted to threadably engage with the male threads of the stem boss.

7. The assembly of claim 6, wherein the hub body further comprises a radial flange extending outwardly and transversely with respect to the cylinder section, the radial flange having a flange face adapted to receive the motor/actuator.

8. The assembly of claim 7, further comprising:
an aperture created in the radial flange; and
a fastener inserted through the aperture to releasably engage the motor/actuator with the radial flange.

9. The assembly of claim 1, further comprising:
a shoulder section of the adapter member; and
a flange extending radially outward from the first end of the stem extender, the flange engageable with the shoulder section of the adapter and operable to retain the flange between the stem and the adapter.

10. The assembly of claim 1, wherein the first end of the stem extender further comprises a slot adapted to engage with a male end of the stem.

11. A sealing hub assembly, comprising:
a valve having a stem boss and a stem rotatably received in the stem boss, the stem adapted for rotation by a motor/actuator;
a hub body fixedly connected to the stem boss, and operable to releasably mount the motor/actuator;
an adapter threadably engaged to the hub body;
a stem extender retained by the adapter, the stem extender coupled at a first end for co-rotation with the stem, and coupled at a second end to the motor/actuator;
a first seal positioned between the stem extender and the adapter; and
a second seal positioned between the adapter and the stem boss.

12. The assembly of claim 11, wherein the first seal comprises an O-ring.

13. The assembly of claim 12, wherein the stem extender further comprises an annular groove adapted to receive the O-ring.

14. The assembly of claim 11, wherein the second seal further comprises a washer-type seal.

15. The assembly of claim 11, further comprising:
a plurality of male threads of the stem boss; and
a cylinder section of the hub body having internal female threads adapted to threadably engage with the male threads of the stem boss.

16. The assembly of claim 15, wherein the hub body further comprises a radial flange extending outwardly and transversely with respect to the cylinder section, the radial flange having a flange face adapted to receive the motor/actuator.

17. The assembly of claim 16, further comprising:
a first aperture created in the radial flange; and
a fastener inserted through the first aperture to releasably engage the motor/actuator with the radial flange.

18. The assembly of claim 17, further comprising:
a second aperture created in the radial flange; and
an outer sleeve of the adapter sized to be slidably received in the second aperture;
wherein the second seal is positioned for engagement with an inner bore wall of the outer sleeve.

19. The assembly of claim 11, further comprising:
a shoulder section of the adapter; and
a flange extending radially outward from the first end of the stem extender, the flange engageable with the shoulder section of the adapter to retain the flange between the stem and the adapter.

20. The assembly of claim 11, wherein the first end of the stem extender further comprises a slot adapted to engage with a male end of the stem.

21. The assembly of claim 11, wherein the valve further comprises:
a valve body;
an inlet branch welded to the valve body;
an outlet branch welded to the valve body;
a valve flow path defined through the inlet branch, the valve body and the outlet branch;
a ball rotatably positioned within the flow path and operable to selectively open and close the flow path.

22. A method for installing a sealing assembly between a valve and a valve motor/actuator operable to externally seal a leaking stem seal, the sealing assembly having a cylindrical portion and a flange portion, an adapter engageable with the cylindrical portion and a stem extender, the valve having a stem rotatably received within a stem boss, the method comprising:
positioning the first sealing member on the stem extender;
inserting the stem extender into the adapter to operably engage the first sealing member between the stem extender and the adapter;
urging the adapter into engagement with the flange portion;
positioning a second sealing member between the adapter and the stem boss; and
releasably engaging the cylindrical portion to the stem boss to operably engage the second sealing member to both the adapter and the stem boss.

23. The method of claim 22, further comprising releasably fastening the motor/actuator to the flange portion of the sealing assembly.

24. The method of claim 23, further comprising coupling the stem extender to the motor/actuator.

25. The method of claim 22, further comprising coupling a slotted end of the stem extender to the stem during the engaging step.

26. The method of claim 22, further comprising inserting a fastener through the cylindrical portion to releasably lock the cylindrical portion to the stem boss.

27. The method of claim 22, further comprising creating an annular groove in the stem extender operable to receive the second sealing member prior to the inserting step.

28. The method of claim 22, further comprising:
forming female threads within the cylindrical portion; and
creating external male threads on the adapter operable to threadably engage the female threads.

29. The method of claim 22, further comprising coaxially aligning the stem extender with the stem.

30. The method of claim 22, further comprising:
extending a radial flange from the stem extender; and
creating a shoulder in the adapter operable to abuttingly receive the radial flange during the inserting step.
